(19) United States
(12) Patent Application Publication
(10) Pub. No.: US 2026/0074582 A1
(43) Pub. Date: Mar. 12, 2026

(54) ROTARY POSITIONING DEVICE AND ITS APPLICATION METHOD

(71) Applicant: CHING-LIEN HSU, NEW TAIPEI CITY (TW)

(72) Inventor: CHING-LIEN HSU, NEW TAIPEI CITY (TW)

(21) Appl. No.: 18/829,446

(22) Filed: Sep. 10, 2024

(51) Int. Cl. H02K 7/02; H02K 7/00; H02K 7/18

(52) U.S. Cl. CPC H02K 7/02; H02K 7/003; H02K 7/1823

(57) ABSTRACT

A counterweight self-rotating power generating device includes a motor, a counterweight self-rotating power unit, a flywheel and a power generating device. By rotating the power wheel to generate non-offset rotational kinetic energy generated by the counterweight on it and the inertial kinetic energy generated by the flywheel to drive the power generating device to generate electricity.

### BACKGROUND OF THE INVENTION

### 1. Field of the Invention

The present invention relates to power generation technology, especially refers to a counterweight self-rotating power generating device designed to generate continuous rotational force by rotating the power wheel to generate non-offset rotational kinetic energy generated by the counterweight on it and the inertial kinetic energy generated by the flywheel to drive the generator to generate electricity.

### 2. Description of the Related Art

There are many types of generators known to us, such as wind power, water power and thermal power. Wind turbines require professional evaluation and must be installed in areas with sufficient wind all year round. Although the cost of generating electricity is lower than that of thermal power generation, its efficiency is quite poor when there is no wind or insufficient wind. Its equipment and maintenance costs are also high. Large-scale installation also destroys the landscape and habitats, and requires a lot of land. Hydropower uses the potential energy of water to drive the generator to generate electricity, so most of them need to be located in places with large water sources, such as reservoirs. However, hydropower cannot generate electricity during dry seasons or when there is insufficient water. Long-term research has found that hydropower generated in reservoirs will produce a large amount of greenhouse gas methane, causing environmental damage to the reservoirs.

Solar and geothermal power generation have high construction costs and expensive maintenance, but their efficiency in generating electricity is quite limited. In particular, the efficiency of solar power generation depends on sunlight. When the sunlight is too strong or too weak, the efficiency of power generation will be affected. Moreover, solar panels have a certain lifespan. As mentioned above, the large-scale use of solar power generation requires a lot of land and space, is costly, and discarded solar panels will also cause pollution.

Others, such as thermal power generation, rely on burning fossil fuels such as coal, natural gas or oil to generate electricity. But thermal power generation will emit a large amount of carbon dioxide. According to relevant data, for every kilowatt-hour of electricity generated by thermal power generation, lignite emits three times as much carbon dioxide as natural gas. The large-scale emission of this greenhouse gas has led to global warming and rising sea levels, not to mention that it still contains harmful substances that have a significant impact on human health.

### SUMMARY OF THE INVENTION

The main object of the present invention is to generate continuous rotational force to drive the power generating device to generate electricity by utilizing the non-offset rotational kinetic energy generated by the counterweight on the power wheel and the inertial kinetic energy generated by the flywheel when the power wheel rotates.

To achieves this and other objects of the present invention, the present invention relates to a counterweight self-rotating power generating device, which includes a motor, a counterweight self-rotating power unit, at least one flywheel and at least one power generating device. The counterweight self-rotating power unit includes a set of power wheels that are arranged in a corresponding and axially offset manner and at least one counterweight unit that is pivotally arranged between the two power wheels. The counterweight unit includes a counterweight seat, a counterweight, and an extension arm connected between the counterweight seat and the counterweight. Two axis-offset shafts are respectively disposed on the two sides of the counterweight seat. The axis-offset shafts are respectively pivoted on the two power wheels, and the axis-offset shafts of the two counterweight seats are at the same distance from the axis center of the two power wheels. The motor drives a synchronous shaft through a chain and cooperates with the chain to synchronously drive the power wheels to rotate stably, and during the rotation, the counterweight seat and counterweight of the counterweight unit which are staggered in the periphery thereof are kept in the same horizontal moving state. In combination with the extension arm provided between the counterweight seat and the counterweight, the counterweight unit generates effective gravity around one side of the center of the power wheels to push the power wheels. At the same time, the counterweight unit located on the other side of the center of the power wheels is hidden inside the power wheels, so that the load force is much smaller than the effective thrust generated by the counterweight unit on the other side of the center of the power wheels. At the same time, the stable drive generated by the motor and the inertial kinetic energy generated by the flywheel driven synchronously by the power wheels are combined to drive the power generating device to generate electricity through the continuous rotational force generated by the above, so as to provide electricity for use and provide an environmentally friendly, efficient and low-maintenance power generating device.

Preferably, the motor drives the synchronous shaft with a chain, and the sprocket on the synchronous shaft is connected to a chain to synchronously drive sprockets on the frame. The sprockets are connected to one of the sprockets provided on the power wheel shaft of each of the power wheels by a respective chain, so as to synchronously drive the power wheels. At the same time, when the power wheels rotate, another sprocket respectively arranged on the power wheel shaft drives another second intermediate transmission shaft arranged on the frame through a chain, and the second intermediate transmission shaft drives a sprocket provided on the flywheel shaft on one side of the flywheel via a chain to rotate the flywheel to generate inertial continuous kinetic energy, and then drives a power generating device via a chain via another sprocket provided on the flywheel shaft to generate electricity.

Preferably, the motor used in the invention is a low power motor with low power consumption. The reducer on the motor makes the low-power motor produce a high torque output with reduced speed. Therefore, only low-power power is needed to provide the low-power motor to drive the power wheel to start rotating. When the power wheels start to rotate, the counterweight unit generates effective thrust to make the power wheels rotate continuously, and the inertial kinetic energy generated by the synchronously driven flywheels together constitutes the power to continuously drive the power generating device to generate electricity. After the power wheels and the flywheels are in normal operation, the low-power motor no longer drives the power wheels, but serves to stabilize and smoothly move the entire mechanism. Therefore, after the overall operation and power generation, in addition to generating sufficient electricity for use, the power consumption rate of the low-power motor is lower than the power consumed at the beginning of starting the power wheels and flywheel rotation, which is more energy-saving and therefore does not cause a burden.

### BRIEF DESCRIPTION OF THE DRAWINGS

FIG. 1 is a front view of one of the preferred embodiment of the present invention.

FIG. 2 is a side view of the present invention.

FIG. 3 is a diagram showing the position of the counterweight unit when the power wheel of the present invention is rotated to a certain angle.

FIG. 4 is a diagram showing a different position of the counterweight unit when the power wheel of the present invention is rotated to another angle.

FIG. 5 is a diagram showing an application example of the present invention in which the generator supplies power to a low-power motor.

FIG. 6 is a diagram showing an embodiment of the present invention in which the power wheel is configured in a polygonal shape.

### DETAILED DESCRIPTION OF THE INVENTION

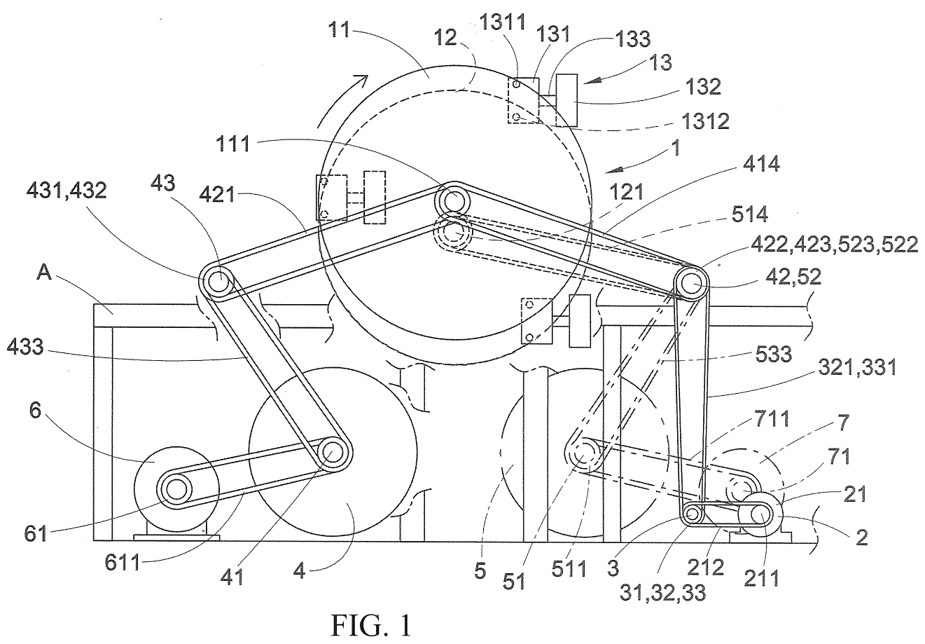

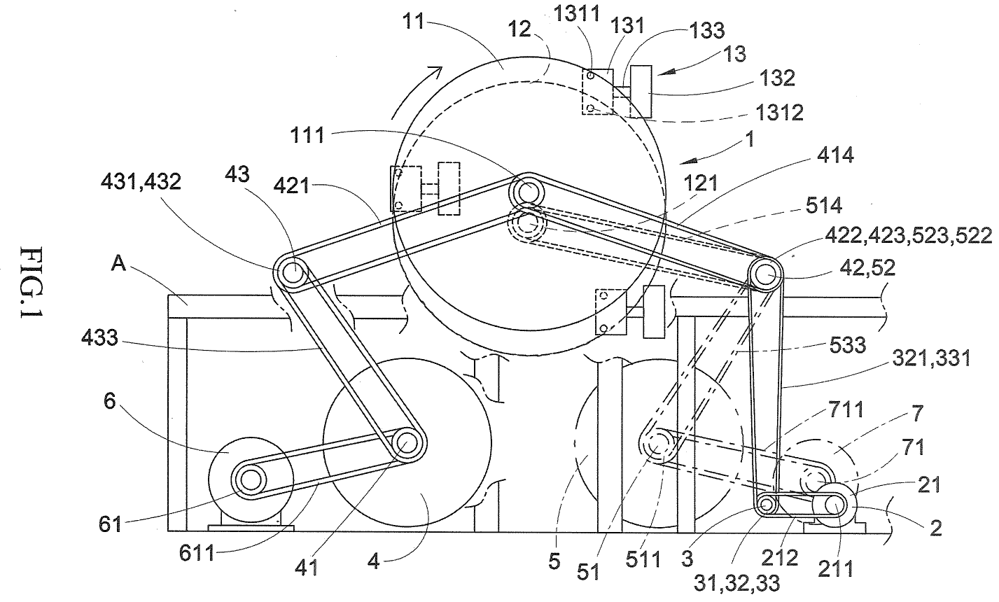

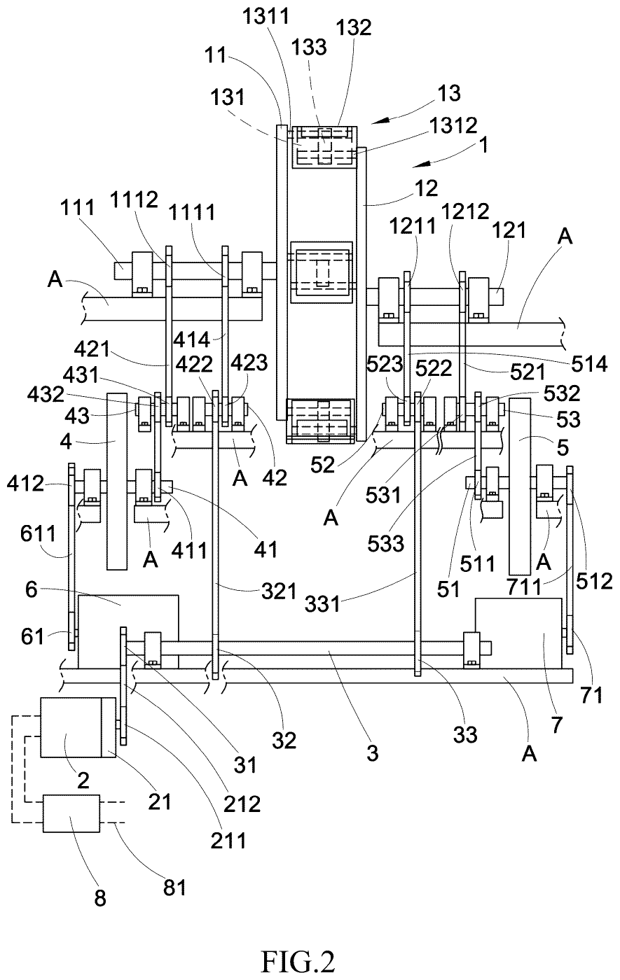

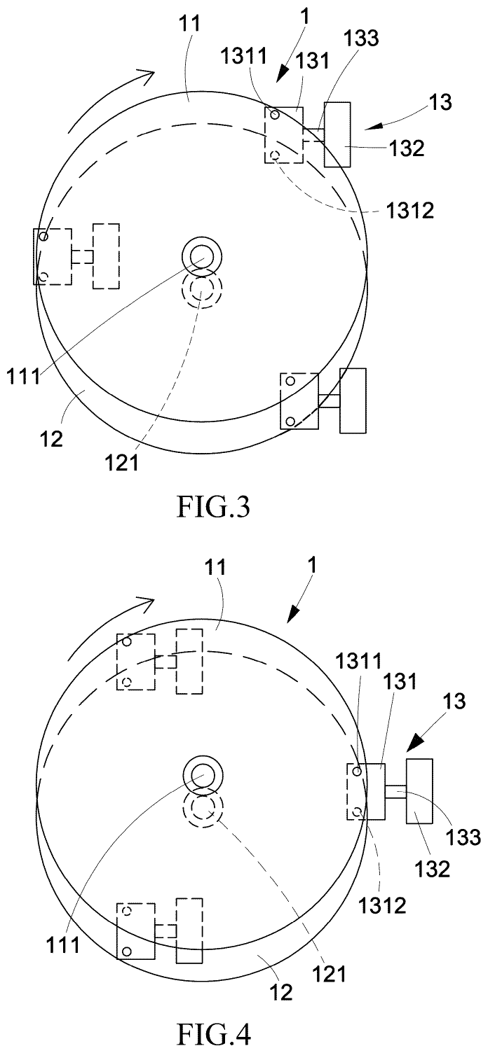

Please refer to FIG. 1 and FIG. 2, the present invention is related to a counterweight self-rotating power generating device, which comprises a motor 2, a counterweight self-rotating power unit 1, at least one flywheel 4, 5 and at least one power generating device 6, 7. The counterweight self-rotating power unit 1 comprises a pair of power wheels 11, 12 which are arranged in a corresponding manner and with an axial offset, and at least one counterweight unit 13 which is arranged in a staggered manner according to the cardinality of the counterweight units and pivotally disposed between the two power wheels 11, 12. The power wheels 11 and 12 are respectively disposed on a respective power wheel shaft 111 and 121, and the power wheel shaft 111 and 121 are disposed on a frame A. The counterweight unit 13 comprises a counterweight seat 131, a counterweight 132, and an extension arm 133 connected between the counterweight seat 131 and the counterweight 132. The two side surfaces of the counterweight seat 131 are respectively provided with two axis-offset shafts 1311, 1312, the axis-offset shafts 1311, 1312 are respectively pivoted on the inner side surfaces of the two power wheels 11, 12, and the two axis-offset shafts 1311, 1312 of the counterweight seat 131 are the same as the axis-offset distances of the two power wheels 11, 12. The frame A is provided with the motor 2 and a synchronous shaft 3 with three sprockets 31, 32, 33. The sprocket 211 disposed in front of the reducer 21 of the motor 2 drives one of the sprockets 31 disposed on the synchronous shaft 3 through a chain 212. Two first intermediate transmission shafts 42, 52 are provided on the frame A corresponding to the synchronous shaft 3 and the two power wheels 11, 12. Two sprockets 422, 423, 522, 523 are provided on each first intermediate transmission shaft 42, 52. The power wheel shafts 111, 121 of the power wheels 11, 12 are also provided with two sprockets 1111, 1112, 1211, 1212 respectively. The two sprockets 32 and 33 provided on the synchronous shaft 3 are synchronously driven by chains 321 and 331 to drive one of the sprockets 422 and 522 provided on each of the two first intermediate transmission shafts 42 and 52. Then, the other sprocket 423, 523 provided on each of the two first intermediate transmission shafts 42 and 52 drives one of the sprockets 1111, 1211 provided on the two power wheel shafts 111, 121 synchronously with a respective chain 414, 514, thereby driving the power wheels 11, 12 to rotate stably. When the power wheels 11 and 12 rotate, the counterweight seat 131 and counterweight 132 of the counterweight unit 13 disposed therebetween are kept moving in the same horizontal direction, and when the power wheels 11 and 12 rotate stably, the counterweight unit 13 on one side of the center is kept protruding. In combination with the extension arm 133 disposed between the counterweight seat 131 and the counterweight 132, the gravity generated by the counterweight 132 extending from the end of the extension arm 133 on one side of the periphery protruding from the center of the power wheels 11, 12 effectively drives the power wheels 11, 12 to rotate. At the same time, the counterweight unit 13 located at the other side of the center of the power wheels 11, 12 is hidden inside the power wheels 11, 12, so that when the power wheels 11, 12 rotate, the load force on one side of the center of the power wheels 11, 12 is much smaller than the effective thrust generated by the counterweight unit 13 on the other side of the center, so that the power wheels 11 and 12 have sufficient counterweight to push against the gravity and produce continuous rotation (as shown in FIGS. 3 and 4). At the same time, at least one flywheel 4, 5 is disposed on the frame A, and a second intermediate transmission shaft 43, 53 is disposed on the frame A between each flywheel 4, 5 and each power wheel 11, 12. Two sprockets 431, 432, 531, 532 are respectively provided on each of the two second intermediate transmission shafts 43, 53. Two sprockets 411, 412, 511, 512 are provided on the flywheel shafts 41, 51 of the flywheels 4, 5. The respective other sprocket 1112, 1212 disposed on the two power wheel shafts 111, 121 is respectively connected to one respective sprocket 431, 531 of the two second intermediate transmission shafts 43, 53 by a respective chain 421, 521, and the respective other sprocket 432, 532 is further connected to one respective sprocket 411, 511 disposed on the flywheel shaft 41, 51 by a respective chain 433, 533 to simultaneously drive the flywheel 4, 5 to rotate and generate inertial kinetic energy. Finally, the respective other sprocket 412, 512 provided on the flywheel shaft 41, 51 is connected to the sprocket 61, 71 provided on the power generating device 6, 7 by a chain 611, 711 respectively to drive the power generating device 6, 7 to generate electricity. In this case, in addition to the sprockets and chains used to drive the various parts, gears and drive shafts can also be used to connect and drive the various parts.

The present invention uses the motor 2 and the reducer 21 to produce a deceleration and a stable driving force with a sufficient stable rotation speed to drive the power wheels 11 and 12 with effective thrust generated by the counterweight unit 13 to rotate continuously. In addition, the inertial kinetic energy generated by the flywheels 4 and 5 driven synchronously by the power wheels 11 and 12 is used to drive the power generating devices 6 and 7 to generate electricity, thereby providing electric power for use and providing an environmentally friendly, highly efficient and low-maintenance power generating device.

The motor 2 used in the present invention is a low-power motor with low power consumption. The reducer 21 on motor 2 reduces the speed of the low-power motor 2 and generates a stable high torque output. Therefore, only a low-power power source is needed to be provided to the low-power motor 2 to drive the power wheels 11 and 12 to start rotating. When the power wheels 11 and 12 start to rotate, the counterweight unit 13 as described above generates effective thrust to make the power wheels 11 and 12 generate a power source for continuous rotation, and the inertial kinetic energy generated by the synchronously driven flywheels 4, 5 together constitutes a power source for continuously driving the power generating devices 6, 7 to generate electricity. Therefore, the role played by motor 2 is only to provide the power required to drive the power wheels 11 and 12 to start rotating. When the power wheels 11, 12 start to rotate, the counterweight unit 13 generates effective thrust to make the power wheels 11, 12 generate a power source for continuous rotation. After the power wheels 11, 12 and the flywheels 4, 5 operate normally, the low-power motor 2 is disconnected and no longer plays the role of driving the power wheels 11, 12. In the later stage, the motor 2 is only responsible for stabilizing the stable rotation of the power wheels 11 and 12 and making the entire mechanism run smoothly. Therefore, after the overall operation and power generation, in addition to generating sufficient electricity for use, the power consumption rate of the low-power motor 2 is lower and more energy-saving than the power consumed at the beginning of starting the power wheels 11 and 12. Therefore, the burden on the motor 2 is already quite low.

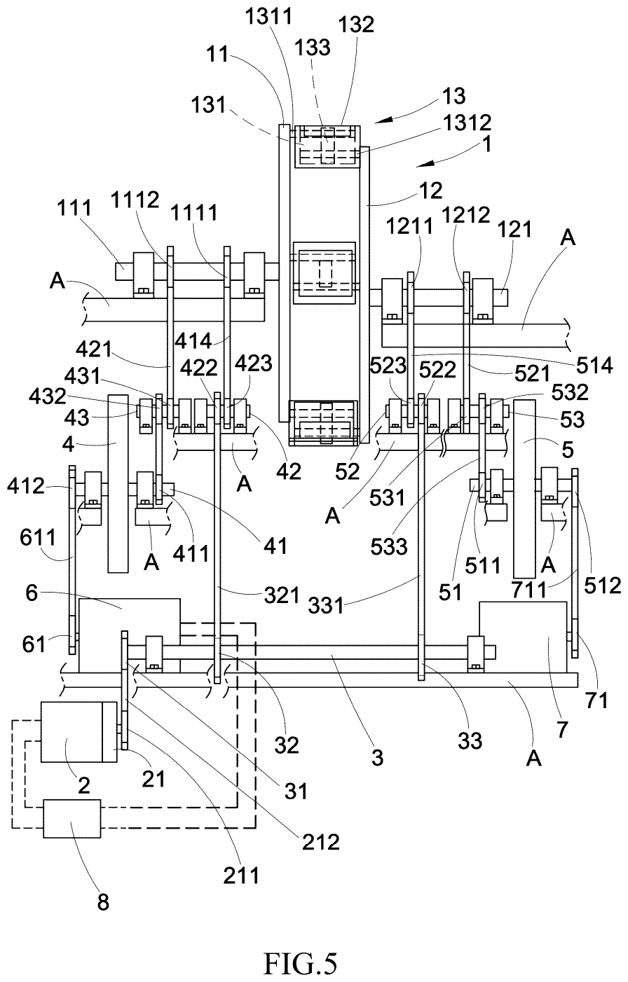

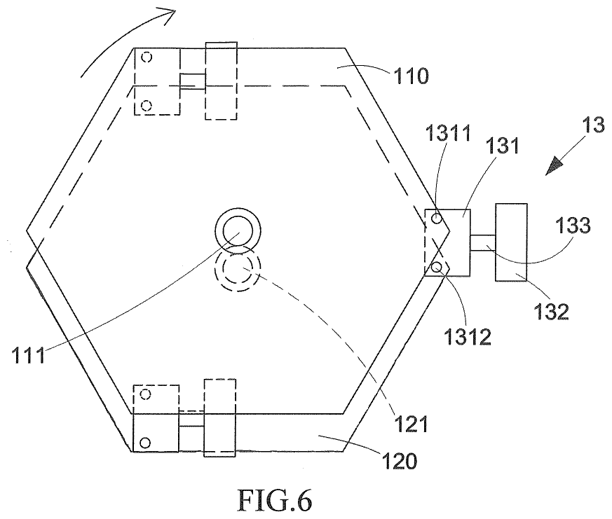

The low power motor 2 can be powered directly by the mains 81 or by a battery 8 connected to a charging device. Of course, the power generated by the power generating devices 6 and 7 of the present invention is much greater than the power consumed by the low-power motor 2. Therefore, a very small amount of the electricity generated by the power generating devices 6 and 7 can be returned to the battery 8, and then the battery 8 supplies power to the low-power motor 2 to generate continuous operation and power generation (as shown in FIG. 5). Furthermore, the power wheels 110, 120 can be of polygonal design (as shown in FIG. 6). In summary, the present invention provides a device that can generate continuous rotational kinetic energy to drive a power generating device to generate electricity, thereby providing electricity for use, and providing environmental protection, high efficiency and low maintenance costs.

This invention has been actually implemented and tested, and a physical structure has been completed. After testing, its efficacy has achieved the expected efficacy as described in this invention, so a patent application is filed in accordance with the law.

What is claimed is:

1. A counterweight self-rotating power generating device, comprising a motor, a counterweight self-rotating power unit, at least one flywheel and at least one power generating device, said counterweight self-rotating power unit comprising a pair of power wheels arranged in a corresponding manner and with an axial offset and at least one counterweight unit pivotally disposed between said two power wheels, said power wheels being respectively disposed on a respective power wheel shaft on a frame, said counterweight unit being provided with two axis-offset shafts on both sides thereof, said two axis-offset shafts being respectively pivoted on respective inner surfaces of said two power wheels, said frame being equipped with said motor and a synchronous shaft, said motor driving said synchronous shaft on said frame through a reducer to make said synchronous shaft rotate, two first intermediate transmission shafts being provided on said frame corresponding to said synchronous shaft and said two power wheels, said synchronous shaft synchronously driving said two first intermediate transmission shafts to synchronously drive said power wheels to rotate, said counterweight units being kept moving in the same horizontal direction when said power wheels rotate, so that the gravity generated by the said counterweight unit on one side of the center of said power wheels effectively drives said power wheels to rotate and at the same time, the said counterweight unit located at the other side of the center of said power wheels is hidden inside said power wheels, so that when said power wheels rotate, the load force on one side of the center of said power wheels is much smaller than the effective thrust generated by said counterweight unit on the other side of the center, so that said power wheels have enough counterweight gravity to generate continuous rotation, said at least one flywheel being disposed on said frame, each said flywheel being disposed on a flywheel shaft, a second intermediate transmission shaft being disposed on said frame between each said flywheel and each said power wheel, so that said two power wheel shafts simultaneously drive the said two power wheel shafts simultaneously drive the said second intermediate transmission shaft between each said flywheel and each said power wheel to rotate, and then the said second intermediate transmission shaft drives the said flywheel to rotate to generate inertial kinetic energy, and finally the said flywheel drives the said power generating device to generate electricity.

2. The counterweight self-rotating power generating device as claimed in claim 1, wherein said synchronous shaft is provided with three sprockets; said reducer of said motor is provided with a sprocket for driving one said sprockets on said synchronous shaft on said frame through a chain to make said synchronous shaft rotate; each said first intermediate transmission shaft is provided with two sprockets; said power wheel shaft of each said power wheel is provided with two sprockets; the other said two sprockets on said synchronous shaft drive one of the said sprockets on said two first intermediate transmission shafts synchronously with a respective chain, and then the other said sprocket on said two first intermediate transmission shafts drives one of the said sprockets on said two power wheel shafts synchronously with a respective chain, thereby synchronously driving said power wheels to rotate; said flywheel shaft is provided with two sprockets, said second intermediate transmission shaft is provided with two sprockets between each said flywheel and each said power wheel; the other said sprockets on said two power wheel shafts are connected to one of the said sprockets on said second intermediate transmission shaft by a chain, and the other said sprockets on said two second intermediate transmission shafts are connected to one of the said sprockets on said flywheel shaft by a chain to simultaneously drive said flywheel to rotate and generate inertial kinetic energy, and finally, the other said sprocket installed on said flywheel shaft is connected to the said sprocket installed on said power generating device through a chain to drive said power generating device to generate electricity.

3. The counterweight self-rotating power generating device as claimed in claim 1, wherein said counterweight unit comprises a counterweight seat, a counterweight, and an extension arm connected between said counterweight seat and said counterweight; said two axis-offset shafts have respective one ends thereof respectively pivoted at two sides of said counterweight seat in a one high and one low manner, and respective outer ends of said two axis rods are pivoted on respective inner surfaces of said two power wheels respectively.

4. The counterweight self-rotating power generating device as claimed in claim 1, wherein the said counterweight units pivotally arranged between said two power wheels are staggered according to the cardinality of said counterweight units.

5. The counterweight self-rotating power generating device as claimed in claim 1, wherein said motor is a low-power motor with low power consumption, and said reducer disposed on said motor is used to decelerate said low-power motor and generate a stable high torque output, so that only a low-power power source is required to be provided to said low-power motor to drive said power wheels to start rotating.

6. The counterweight self-rotating power generating device as claimed in claim 1, wherein said motor is capable of being powered directly by mains electricity or by a battery connected to a charging device.

7. The counterweight self-rotating power generating device as claimed in claim 1, wherein the power used by said motor is generated by a power generating device, with a very small amount of power flowing back to a battery, and then said battery supplies power to said motor to generate continuous power generation.

8. The counterweight self-rotating power generating device as claimed in claim 1, wherein said power wheels may be of polygonal design.

9. The counterweight self-rotating power generating device as claimed in claim 2, wherein in addition to using sprockets and chains to drive various parts, gears and drive shafts are able to be used to connect and drive various parts.
